(19) United States
(12) Patent Application Publication
(10) Pub. No.: US 2005/0266757 A1
(43) Pub. Date: Dec. 1, 2005

(54) Static free wet use chopped strands (WUCS) for use in a dry laid process

(76) Inventors: Bertrand J. Roekens, Heusy (BE); Enamul Haque, Novi, MI (US); Steven E. Baker, Amarillo, TX (US)

Correspondence Address: OWENS CORNING, 2790 COLUMBUS ROAD, GRANVILLE, OH, 43023, US

(21) Appl. No.: 11/178,769

(22) Filed: Jul. 11, 2005

Related U.S. Application Data
(63) Continuation-in-part of application No. 10/688,013, filed on Oct. 17, 2003.

(51) Int. Cl. B32B 27/04; B32B 27/12

(52) U.S. Cl. 442/327; 442/108; 442/110

(57) ABSTRACT

A method of forming a chopped strand mat formed of bonding materials and wet use chopped strand glass fibers (WUCS) which demonstrate a reduced occurrence of static electricity is provided. In one exemplary embodiment, the occurrence of static electricity on the glass fibers is reduced or eliminated by increasing the total solids content on the glass fibers, such as by applying an increased or excess amount of size composition to the glass fibers. Alternatively, an anti-static agent may be added directly to the sizing composition and applied to the glass filaments by any suitable application device. The antistatic agent may be applied to the wet chopped strand glass prior to chopping the strands or as the wet chopped strands are packaged. The static free wet use chopped strand glass fibers may be used in dry-laid processes to form chopped strand mats having a reduced tendency to accumulate static electricity.

### CROSS REFERENCE TO RELATED APPLICATIONS

This application is a continuation-in-part of U.S. patent application Ser. No. 10/688,013 entitled “Development Of Thermoplastic Composites Using Wet Use Chopped Strand Glass In A Dry Laid Process” filed Oct. 17, 2003, the content of which is incorporated by reference in its entirety.

### TECHNICAL FIELD AND INDUSTRIAL APPLICABILITY OF THE INVENTION

The present invention relates generally to reinforced composite products, and more particularly, to a method of forming a chopped strand mat formed of bonding materials and reinforcing fibers which demonstrate a reduced occurrence of static electricity.

### BACKGROUND OF THE INVENTION

Typically, glass fibers are formed by drawing molten glass into filaments through a bushing or orifice plate and applying a sizing composition containing lubricants, coupling agents, and film-forming binder resins to the filaments. When the fibers are to be chopped and stored and/or formed as wet use chopped strand glass, a low solids sizing composition that contains high dispersive chemistries are applied to the glass strands. Such a sizing aids in the dispersion of the wet chopped glass fibers in the white water solution during a wet-laid process in which the chopped fibers are dispersed in an aqueous solution and formed into a fibrous mat product. The aqueous sizing composition also provides protection to the fibers from interfilament abrasion and promotes compatibility between the glass fibers and any matrix in which the glass fibers are to be used for reinforcement purposes.

After the sizing composition is applied, the fibers may be gathered into one or more strands and wound into a package or, alternatively, the fibers may be chopped while wet and collected. The collected chopped strands can then be dried and cured to form dry use chopped strand glass (DUCS), or they can be packaged in their wet condition as wet use chopped strand glass (WUCS). Such dried chopped glass fiber strands are commonly used as reinforcement materials in thermoplastic articles. It is known in the art that glass fiber reinforced polymer composites possess higher mechanical properties compared to unreinforced polymers. Thus, better dimensional stability, tensile strength and modulus, flexural strength and modulus, impact resistance, and creep resistance can be achieved with glass fiber reinforced composites.

Fibrous mats, which are one form of fibrous non-woven reinforcements, are extremely suitable as reinforcements for many kinds of synthetic plastic composites. The two most common methods for producing glass fiber mats from chopped glass fibers are wet-laid processing and dry-laid processing. Generally, in a conventional wet-laid process, the wet chopped fibers are dispersed in a water slurry which may contain surfactants, viscosity modifiers, defoaming agents, or other chemical agents. Once the chopped glass fibers are introduced into the slurry, the slurry is agitated so that the fibers become dispersed. The slurry containing the fibers is deposited onto a moving screen, and a substantial portion of the water is removed to form a web. A binder is then applied, and the resulting mat is dried to remove the remaining water and cure the binder. The formed non-woven mat is an assembly of dispersed, individual glass filaments. Wet-laid processes are commonly used when a very uniform distribution of fibers is desired.

Conventional dry-laid processes include processes such as an air-laid process and a carding process. In a conventional air-laid process, dried glass fibers are chopped and air blown onto a conveyor or screen and consolidated to form a mat. For example, dry chopped fibers and polymeric fibers are suspended in air, collected as a loose web on a screen or perforated drum, and then consolidated to form a randomly oriented mat. In a conventional carding process, a series of rotating drums covered with fine wires and teeth comb the glass fibers into parallel arrays to impart directional properties to the web. The precise configuration of the drums will depend on the mat weight and fiber orientation desired. The formed web may be parallel-laid, where a majority of the fibers are laid in the direction of the web travel, or they can be random-laid, where the fibers have no particular orientation.

Dry-laid processes are particularly suitable for the production of highly porous mats and are suitable where an open structure is desired in the resulting mat to allow the rapid penetration of various liquids or resins. However, such conventional dry-laid processes tend to produce mats that do not have a uniform weight distribution throughout their surface areas, especially when compared to mats formed by conventional wet-laid processes. In addition, the use of dry-chopped input fibers can be more expensive to process than the fibers used in a wet-laid process because the fibers in a dry-laid process are typically dried and packaged in separate steps before being chopped.

For certain reinforcement applications in the formation of composite parts, it is desirable to form fiber mats in which the mat includes an open, porous structure (as in a dry-laid process) and which has a uniform weight (as in a wet-laid process). Therefore, there exists a need in the art for a cost-effective and efficient process for forming a non-woven mat which has a substantially uniform weight distribution, and which has an open, porous structure that can be used in the production of reinforced composite parts that overcomes the disadvantages of conventional wet-laid and dry-laid processes.

### SUMMARY OF THE INVENTION

It is an object of the present invention to provide reinforcement fibers which demonstrate a reduced occurrence of static electricity. The reinforcement fibers are preferably wet use chopped strand glass fibers that are dried and then subsequently used in a dry-laid process. The glass fibers are coated with a size composition containing a film forming agent, a coupling agent, and at least one lubricant. In one embodiment of the invention, the occurrence of static electricity on the glass fibers is reduced or eliminated by increasing the total solids content on the glass fibers, such as by applying excess amount of size composition to the glass fibers. Alternatively, the amount of hydrophilic components present in the size may be increased while the other components in the size are maintained in their original amounts or substantially in their original amounts. The size composition may be applied to the fibers in an amount of from about 0.4 to about 0.20% by weight solids.

In a second embodiment of the invention, an anti-static agent is added directly to the sizing composition, and the modified sizing composition is applied to the surface of the glass fibers, such as by application rollers or a spraying apparatus. The antistatic agent may be any antistatic agent that is soluble in the sizing composition. One or more antistatic agents may be added to the size composition. The antistatic agent may be added to the sizing composition in an amount of from about 0.05 to about 0.20% by weight solids.

In a third embodiment, an antistatic agent is added directly to the glass fibers after the fibers have been sized and chopped. In preferred embodiments, the antistatic agent is sprayed onto the glass fibers to achieve a substantially uniform distribution of antistatic agent on the chopped strands. The antistatic agent may be added to the glass fibers in an amount of from about 0.05 to about 0.20% by weight solids.

It is another object of the present invention to provide a chopped strand mat that demonstrates a reduced tendency to accumulate static electricity. The chopped strand mat contains a bonding material and reinforcement fibers that have been treated to reduce the occurrence of static electricity between the fibers. Preferably, the reinforcement fibers are wet use chopped strand glass fibers that have been treated with an antistatic agent or with an excess of size and/or hydrophilic components as described herein. The bonding material may be any thermoplastic or thermosetting material having a melting point less than the reinforcing fibers. The chopped strand mat has a uniform or substantially uniform distribution of dried chopped glass fibers and bonding fibers which provides improved strength, acoustical properties, thermal properties, stiffness, impact resistance, and acoustical absorbance to the mat.

It is a further object of the present invention to provide a process of forming a chopped strand mat that has a reduced tendency to accumulate static electricity. Reinforcement fibers that have been treated to reduce the occurrence of static electricity between the fibers and a bonding material such as the wet use chopped strand glass fibers discussed herein are dried and mixed with bonding fibers. It is desirable to distribute the dried chopped fibers and bonding fibers as uniformly as possible. The mixture of dry chopped glass fibers and bonding fibers are then formed into a sheet. One or more sheet formers may be utilized in forming the chopped strand mat. The sheet may be passed through a thermal bonder to thermally bond the reinforcement fibers and polymer fibers and form the chopped strand mat.

It is an advantage of the present invention that the wet use chopped strand glass fibers treated with an antistatic agent or with an excess of size and/or hydrophilic components within the size as described herein forms a chopped strand mat that is static free or substantially static free. The reduction in the occurrence of static electricity on the glass fibers results in an improvement in the ability to control the distribution of the wet use chopped strand glass fibers (or other reinforcement fibers) and bonding fibers in the chopped strand mat, and assists in forming a mat that has a substantially even distribution of glass fibers and bonding fibers.

It is also an advantage of the present invention that the static free wet use chopped strand glass fibers eliminates the need for the presence of anti-static bars or other antistatic equipment in the mat manufacturing line. Further, the static free fibers eliminates the need for the use an anti-static chemical mixture in the manufacturing line of the chopped strand mat. The reduction or elimination of static electricity on the dried wet use chopped strand glass fibers also creates a worker-friendly environment by reducing the amount of free fibers or fibers in the air in the workplace and reducing potential irritation to workers forming the mats that may be caused by the “free” glass fibers.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a flow diagram illustrating steps for using wet reinforcement fibers in a dry-laid process according to one aspect of the present invention; and

FIG. 2 is a schematic illustration of an air-laid process using wet use chopped strand glass fibers to form a chopped strand mat according to at least one exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. The terms “top”, “bottom”, “side”, and the like are used herein for the purpose of explanation only. It will be understood that when an element is referred to as being “on”, “adjacent to”, or “against” another element, it can be directly on, directly adjacent to, or directly against the other element or intervening elements may be present. It will also be understood that when an element is referred to as being ”over” another element, it can be directly over the other element, or intervening elements may be present. In addition, the terms “reinforcing fibers” and “reinforcement fibers” may be used interchangeably herein. The terms “bonding fibers” and “bonding material” and the terms “size” and “sizing”, respectively, may be interchangeably used. It is to be noted that like numbers found throughout the figures denote like elements.

The invention relates to reinforcement fibers which demonstrate a reduced occurrence of static electricity, a chopped strand mat that demonstrates a reduced tendency to accumulate static electricity, and a process of forming the chopped strand mat. The chopped strand mat is formed of reinforcing fibers and organic bonding fibers. The reinforcing fibers may be any type of organic, inorganic, thermosetting, thermoplastic, or natural fiber suitable for providing good structural qualities as well as good acoustical and thermal properties. Non-limiting examples of suitable reinforcing fibers include glass fibers, wool glass fibers, basalt fibers, natural fibers, metal fibers, ceramic fibers, mineral fibers, carbon fibers, graphite fibers, nylon fibers, rayon fibers, nanofibers, and polymer based thermoplastic materials such as, but not limited to, polyester fibers, polyethylene fibers, polypropylene fibers, polyethylene terephthalate (PET) fibers, polyphenylene sulfide (PPS) fibers, polyvinyl chloride (PVC) fibers, and ethylene vinyl acetate/vinyl chloride (EVA/VC) fibers, and combinations thereof. The chopped strand mat may be entirely formed of one type of reinforcement fiber (such as glass fibers) or, alternatively, more than one type of reinforcement fiber may be used in forming the chopped strand mat. The term “natural fiber” as used in conjunction with the present invention refers to plant fibers extracted from any part of a plant, including, but not limited to, the stem, seeds, leaves, roots, or bast. Preferably, the reinforcement fibers are glass fibers, such as A-type glass, E-type glass, S-type glass, or ECR-type glass such as Owens Corning's Advantex® glass fibers.

The reinforcing fibers may have a length of from approximately 11-75 mm in length, and preferably, a length of from about 12 to about 30 mm. Additionally, the reinforcing fibers may have diameters of from about 8 to about 35 microns, and preferably have diameters of from about 12 to about 23 microns. Further, the reinforcing fibers may have varying lengths and diameters from each other within the chopped strand mat. The reinforcing fibers may be present in the chopped strand mat in an amount of from about 40 to about 90% by weight of the total fibers, and are preferably present in the chopped strand mat in an amount of from about 50 to about 60% by weight.

In the process of the instant invention, wet reinforcement fibers are used in a dry-laid process, such as the dry-laid process described below, to form the chopped strand mat. In a preferred embodiment, wet use chopped strand glass (WUCS) fibers are used as the wet reinforcing fiber. It is desirable that the wet use chopped strand glass fibers have a moisture content of from about 5 to about 30%, and more preferably have a moisture content of from about 5 to about 15%. It is to be noted that although wet use chopped strand glass fibers are described herein as a preferred wet reinforcement fiber, any wet reinforcement fiber identified by one of skill that generates a static charge upon drying may be utilized in the instant invention.

Wet use chopped strand glass for use in the instant invention may be formed by attenuating streams of molten glass from a bushing or orifice and collecting the fibers into a strand. Any suitable apparatus for producing such fibers and collecting them into a strand can be used in the present invention. Once the reinforcing fibers are formed, and prior to their collection into a strand, the fibers are coated with a size composition. The strands are then chopped and collected or packaged in their wet condition. The wet use chopped strand glass may be stored in the form of a bale or bundle of agglomerated individual fibers. The sizing composition is applied to protect the reinforcement fibers from breakage during subsequent processing and to improve the compatibility of the fibers with the matrix resins that are to be reinforced. The size composition also ensures the integrity of the strands of glass fibers (e.g., the interconnection of the glass filaments that form the strand).

In conventional sizing compositions for wet use chopped strand glass, the sizing composition is a low solids sizing composition that contains one or more film forming polymeric or resinous components (film formers), glass-resin coupling agents, and one or more lubricants dissolved or dispersed in a liquid medium. Conventional additives such as biocides may be optionally included in the size composition. A preferred example of such a sizing is Owens Corning's sizing designated as 9501. Other suitable sizings include Owens Corning's wet chopped sizes 9502, 786, 685, 777, 790, and 619.

When wet use chopped strand glass fibers are utilized in a wet-laid process, the fibers remain in a wet condition throughout the formation of the mat and, as a result, there is no generation or accumulation of static electricity between the glass fibers. Therefore, little sizing is needed to protect the wet glass fibers from friction and abrasion, and the sizing is conventionally added at a low weight percentage on the wet glass fibers (e.g., from about 0.10 to about 0.30 wt % solids). However, when wet use chopped strand glass is used in a dry-laid process, there is a potential for a substantial generation of static electricity between the glass fibers as the glass is dried, which may cause safety concerns to workers. In addition, the generation and/or accumulation of static electricity affects the distribution of the reinforcement fibers and bonding fibers in the chopped strand mat formed by the dry-laid process which, in turn, may have a negative impact on the physical and mechanical properties of the mat.

In one exemplary embodiment of the present invention, the occurrence of static electricity on the glass fibers is reduced or eliminated by increasing the total solids content on the wet glass fiber. In the present invention, the increased amount of total solids on the wet fibers is an amount of solids that is greater than the amount of solids conventionally or typically applied to the wet fibers (e.g., wet use chopped strand glass fibers). Although not wishing to be bound by theory, it is believed that hydrophilic components in the size composition act as antistatic agents if they are present in sufficient quantities on the glass fibers. The total solids content on the wet glass fibers may be increased, for example, by applying an increased or excess amount of size composition to the glass fibers. By applying an increased amount of size, the solids content of each of the individual size components on the glass fibers is increased by the same amount and the ratio of the different components forming the sizing is maintained. The size composition may be applied to the wet fibers in an amount of at least about 0.4% by weight solids, preferably in an amount of from about 0.4 to about 2.0% by weight solids, and more preferably in an amount of from about 0.8 to about 1.2% by weight solids.

Alternatively, the amount of hydrophilic components present in the size (such as film formers or lubricants) may be increased while the other components in the size are maintained in their original amounts or substantially in their original amounts. It is desirable that the total amount of hydrophilic components be present on the wet glass fibers in an amount of at least about 0.05% by weight solids, preferably in an amount of from about 0.05 to about 0.2% by weight solids. By increasing the amount of hydrophilic components in the size, the solids content of the hydrophilic components present on the fibers is increased. Due to the high cost of coupling agents, it is desirable to maintain the amount of the coupling agent identical or substantially identical to the amount originally present in the sizing composition.

In an another exemplary embodiment, at least one an anti-static agent is added directly to the sizing composition. This modified sizing composition that includes an antistatic agent is applied to the glass fibers by any suitable application device such as application rollers or a spraying apparatus. Antistatic agents especially suitable for use herein include antistatic agents that are soluble in the sizing composition. Examples of suitable antistatic agents include Katax 6660A (available from Cognis Corporation), Emerstat® 6660 and Emerstat® 6665 (quaternary ammonium antistatic agents available from Emery Industries, Inc.), Neoxil® AO 5620 (cationic organic alkoxylated quaternary ammonium antistatic agent available from DSM Resins), Larostat 264A (quaternary ammonium antistatic agent available from BASF), teteraethylammonium chloride, lithium chloride, fatty acid esters, ethoxylated amines, quaternary ammonium compounds. One or more antistatic agents may be added to the size composition. The antistatic agent may be added to the sizing composition in an amount of at least about 0.05% by weight solids, and preferably in an amount of from about 0.05 to about 0.2% by weight solids.

In an alternate embodiment, the antistatic agent is applied to the wet use chopped strand glass prior to being packaged. The anti-static agent may be sprayed on the glass strands prior to chopping the strands or as the wet chopped strands are being collected and packaged. The amount of anti-static agent applied to the chopped glass may be automatically adjusted pro-rata in accordance with the throughput of the molten glass through the bushings. Preferably, the antistatic agent is sprayed onto the chopped glass to achieve a substantially uniform distribution of antistatic agent on the chopped strands. By spraying the antistatic agent directly onto the glass fibers, there are no issues of solubility or compatibility with the size composition. In addition, spraying the antistatic agent onto the chopped glass reduces waste, as 100% or about 100% of the antistatic agent is placed onto the glass and is not lost in the forming process. The antistatic agent may be added to the glass fibers in an amount of at least about 0.05% by weight, and preferably in an amount of from about 0.05 to about 0.2% by weight solids.

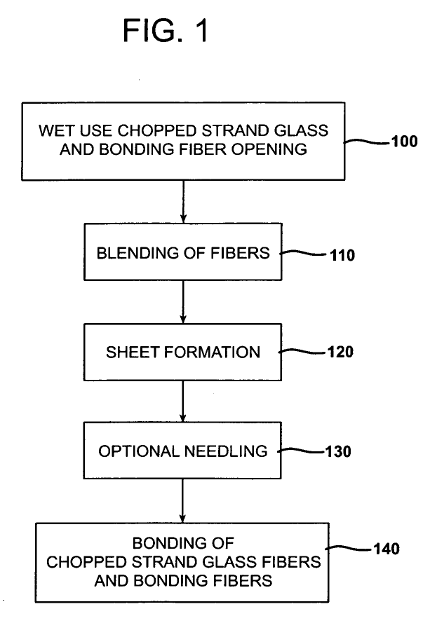

The low static or “static free” wet use chopped strand glass fibers described above may be used in dry-laid processes to form chopped strand mats that have a reduced tendency to accumulate static electricity. An exemplary dry-laid process for forming the chopped strand mat using the low static or “static free” WUCS fibers described above is generally illustrated in FIG. 1, and includes at least partially opening the wet use chopped strand glass fibers and bonding fibers (step 100), blending the chopped glass fibers and bonding fibers (step 110), forming the chopped glass fibers and bonding fibers into a sheet (step 120), optionally needling the sheet to give the sheet structural integrity (step 130), and bonding the chopped glass fibers and bonding fibers (step 140).

The bonding material is not limited, and may be any thermoplastic or thermosetting material having a melting point less than the reinforcing fibers. Examples of thermoplastic and thermosetting materials suitable for use in the chopped strand mat include, but are not limited to, polyester fibers, polyethylene fibers, polypropylene fibers, polyethylene terephthalate (PET) fibers, polyphenylene sulfide (PPS) fibers, polyvinyl chloride (PVC) fibers, ethylene vinyl acetate/vinyl chloride (EVA/VC) fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, nylon, phenolic resins, epoxy resins, and butadiene copolymers such as styrene/butadiene rubber (SBR) and butadiene/acrylonitrile rubber (NBR). It is desirable that one or more types of thermosetting materials be used to form the molding mat. The bonding material may be present in the molding mat in an amount of from about 10 to about 60% by weight of the total fibers, and preferably from about 40 to about 50% by weight.

In addition, the bonding fibers may be functionalized with acidic groups, for example, by carboxylating with an acid such as a maleated acid or an acrylic acid, or the bonding fibers may be functionalized by adding an anhydride group or vinyl acetate. The bonding material may also be in the form of a polymeric mat, a flake, a granule, a resin, or a powder rather than in the form of a polymeric fiber.

The bonding material may also be in the form of multicomponent fibers such as bicomponent polymer fibers, tricomponent polymer fibers, or plastic-coated mineral fibers such as thermosetting coated glass fibers. The bicomponent fibers may be arranged in a sheath-core, side-by-side, islands-in-the-sea, or segmented-pie arrangement. Preferably, the bicomponent fibers are formed in a sheath-core arrangement in which the sheath is formed of first polymer fibers that substantially surround a core formed of second polymer fibers. It is not required that the sheath fibers totally surround the core fibers. The first polymer fibers have a melting point lower than the melting point of the second polymer fibers so that upon heating the bicomponent fibers to a temperature above the melting point of the first polymer fibers (sheath fibers) and below the melting point of the second polymer fibers (core fibers), the first polymer fibers will soften or melt while the second polymer fibers remain intact. This softening of the first polymer fibers (sheath fibers) will cause the first polymer fibers to become sticky and bond the first polymer fibers to themselves and other fibers that may be in close proximity.

Numerous combinations of materials can be used to make the bicomponent polymer fibers, such as, but not limited to, combinations using polyester, polypropylene, polysulfide, polyolefin, and polyethylene fibers. Specific polymer combinations for the bicomponent fibers include polyethylene terephthalate/polypropylene, polyethylene terephthalate/polyethylene, and polypropylene/polyethylene. Other non-limiting bicomponent fiber examples include copolyester polyethylene terephthalate/polyethylene terephthalate (coPET/PET), poly 1,4 cyclohexanedimethyl terephthalate/polypropylene (PCT/PP), high density polyethylene/polyethylene terephthalate (HDPE/PET), high density polyethylene/polypropylene (HDPE/PP), linear low density polyethylene/polyethylene terephthalate (LLDPE/PET), nylon 6/nylon 6,6 (PA6/PA6,6), and glycol modified polyethylene terephthalate/polyethylene terephthalate (6PETg/PET). When bicomponent fibers are used as a component of the bonding material, the bicomponent fibers may be present in an amount up to about 20% by weight of the total fibers.

The bicomponent polymer fibers may have a denier of from about 1 to about 18 denier and a length of from about 2 to about 4 mm. It is preferred that the first polymer fibers (sheath fibers) have a melting point within the range of from about 150 to about 400° F., and even more preferably in the range of from about 170 to about 300° F. The second polymer fibers (core fibers) have a higher melting point, preferably above about 350° F.

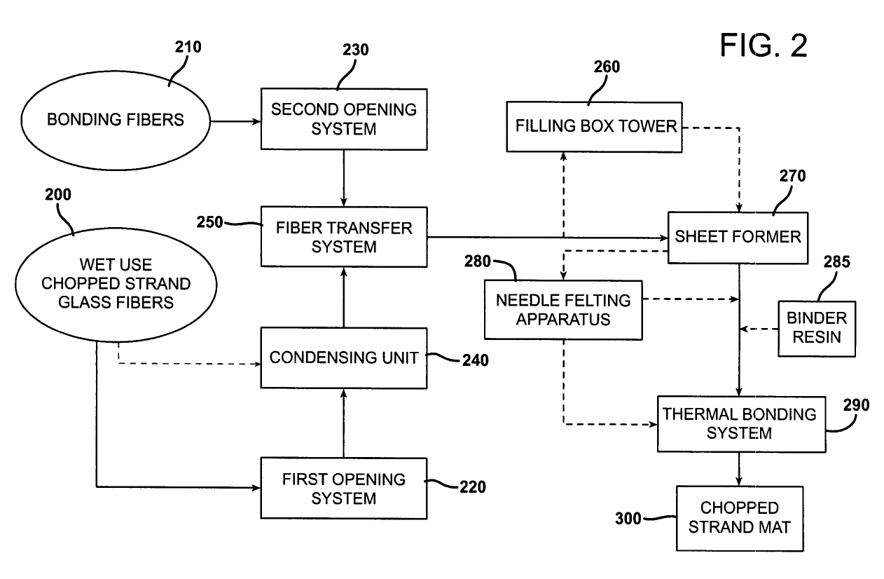

The wet use chopped strand glass fibers and the fibers forming the bonding material are typically agglomerated in the form of a bale of individual fibers. Turning now to FIG. 2, the wet use chopped strand glass fibers 200 are fed into a first opening system 220 and the bonding fibers 210 are fed into a second opening system 230 to at least partially open the wet chopped glass fiber bales and bonding fiber bales respectively. The opening system serves to decouple the clustered fibers and enhance fiber-to-fiber contact. The first and second opening systems 220, 230 are preferably bale openers, but may be any type of opener suitable for opening the bales of bonding fibers 210 and bales of wet use chopped strand glass fibers 200. Suitable openers for use in the present invention include any conventional standard type bale openers with or without a weighing device.

Although the exemplary process depicted in FIGS. 1 and 2 show opening the bonding fibers 210 by a second opening system 230, the bonding fibers 210 may be fed directly into the fiber transfer system 250 if the bonding fibers 210 are present or obtained in a filamentized form (not shown), and not present or obtained in the form of a bale. Such an embodiment is considered to be within the purview of this invention. In alternate embodiments where the bonding material is in the form of a flake, granule, or powder (not shown in FIG. 2), and not a bonding fiber, the second opening system 230 may be replaced with an apparatus suitable for distributing the powdered or flaked bonding material to the fiber transfer system 250 for mixing with the WUCS fibers 200. A suitable apparatus would be easily identified by those of skill in the art. It is also considered to be within the purview of the invention that the wet use chopped strand glass fibers 200 may be fed directly to the condensing unit 240 (FIG. 2), especially if they are provided in a filamentized or partially filamentized form.

The at least partially opened wet use chopped strand glass fibers 200 may be dosed or fed from the first opening system 220 to a condensing unit 240 to remove water from the wet fibers. In exemplary embodiments, greater than about 70% of the free water (water that is external to the reinforcement fibers) is removed. Preferably, however, substantially all of the water is removed by the condensing unit 240. It should be noted that the phrase “substantially all of the water” as it is used herein is meant to denote that all or nearly all of the free water is removed. The condensing unit 240 may be any known drying or water removal device known in the art, such as, but not limited to, an air dryer, an oven, rollers, a suction pump, a heated drum dryer, an infrared heating source, a hot air blower, or a microwave emitting source.

The dried or substantially dried chopped strand glass fibers (not illustrated in FIGS. 1 and 2) and the bonding fibers 210 are blended together by the fiber transfer system 250. In preferred embodiments, the fibers are blended in a high velocity air stream. The fiber transfer system 250 serves both as a conduit to transport the bonding fibers 210 and dried wet use chopped glass fibers to the sheet former 270 and to substantially uniformly mix the fibers in the air stream. It is desirable to distribute the dried chopped fibers and bonding fibers 210 as uniformly as possible. The ratio of dried chopped glass fibers and bonding fibers 210 entering the air stream in the fiber transfer system 250 may be controlled by the weighing device described above with respect to the first and second opening systems 220, 230 or by the amount and/or speed at which the fibers are passed through the first and second opening systems 220, 230. In preferred embodiments, the ratio of dried chopped glass fibers to bonding fibers 210 present in the air stream is 90:10, dried chopped fibers to bonding fibers 210 respectively.

The mixture of dry chopped glass fibers and bonding fibers 210 may be transferred by the air stream in the fiber transfer system 250 to a sheet former 270 where the fibers are formed into a sheet. One or more sheet formers may be utilized in forming the chopped strand mat. In some embodiments of the present invention, the blended fibers are transported by the fiber transfer system 250 to a filling box tower 260 where the dry chopped glass fibers and bonding fibers 210 are volumetrically fed into the sheet former 270, such as by a computer monitored electronic weighing apparatus, prior to entering the sheet former 270. The filling box tower 260 may be located internally in the sheet former 270 or it may be positioned external to the sheet former 270. The filling box tower 260 may also include baffles to further blend and mix the dried chopped glass fibers and bonding fibers 210 prior to entering the sheet former 270. In some embodiments, a sheet former 270 having a condenser and a distribution conveyor may be used to achieve a higher fiber feed into the filling box tower 260 and an increased volume of air through the filling box tower 260. In order to achieve an improved cross-distribution of the opened fibers, the distributor conveyor may run transversally to the direction of the sheet. As a result, the bonding fibers 210 and the dried chopped fibers may be transferred into the filling box tower 260 with little or no pressure and minimal fiber breakage.

The sheet formed by the sheet former 270 contains a substantially uniform distribution of dried chopped glass fibers and bonding fibers 210 at a desired ratio and weight distribution. The sheet formed by the sheet former 270 may have a weight distribution of from about 250 to about 2500 g/m², with a preferred weight distribution of from about 800 to about 1400 g/m².

In one or more embodiments of the invention, the sheet exiting the sheet former 270 is optionally subjected to a needling process in a needle felting apparatus 280 in which barbed or forked needles are pushed in a downward and/or upward motion through the fibers of the sheet to entangle or intertwine the dried chopped glass fibers and bonding fibers 210 and impart mechanical strength and integrity to the mat. Mechanical interlocking of the dried chopped glass fibers and bonding fibers 210 is achieved by passing the barbed felting needles repeatedly into and out of the sheet. An optimal needle selection for use with the particular reinforcement fiber and polymer fiber chosen for use in the inventive process would be easily identified by one of skill in the art.

Although the bonding material 210 is used to bond the dried chopped glass fibers to each other, a binder resin 285 may be added as an additional bonding agent prior to passing the sheet through the thermal bonding system 290. The binder resin 285 may be in the form of a resin powder, flake, granule, foam, or liquid spray. The binder resin 285 may be added by any suitable manner, such as, for example, a flood and extract method or by spraying the binder resin 285 on the sheet. The amount of binder resin 285 added to the sheet may be varied depending of the desired characteristics of the chopped strand mat. A catalyst such as ammonium chloride, p-toluene, sulfonic acid, aluminum sulfate, ammonium phosphate, or zinc nitrate may be used to improve the rate of curing and the quality of the cured binder resin 285.

Another process that may be employed to further bond the reinforcing fibers 200 either alone, or in addition to, the other bonding methods described herein, is latex bonding. In latex bonding, polymers formed from monomers such as ethylene (T_{g} −125° C.), butadiene (T_{g} −78° C.), butyl acrylate (T_{g} −52° C.), ethyl acrylate (T_{g} −22° C.), vinyl acetate (T_{g} 30° C.), vinyl chloride (T_{g} 80° C.), methyl methacrylate (T_{g} 105° C.), styrene (T_{g} 105° C.), and acrylonitrile (T_{g} 130° C.) are used as bonding agents. A lower glass transition temperature (T_{g}) results in a softer polymer. Latex polymers may be added as a spray prior to the sheet entering the thermal bonding system 290. Once the sheet enters the thermal bonding system 290, the latex polymers melt and bond the dried chopped glass fibers together.

A further optional bonding process that may be used alone, or in combination with the other bonding processes described herein is chemical bonding. Liquid based bonding agents, powdered adhesives, foams, and, in some instances, organic solvents can be used as the chemical bonding agent. Suitable examples of chemical bonding agents include, but are not limited to, acrylate polymers and copolymers, styrene-butadiene copolymers, vinyl acetate ethylene copolymers, and combinations thereof. For example, polyvinyl acetate (PVA), ethylene vinyl acetate/vinyl chloride (EVA/VC), lower alkyl acrylate polymer, styrene-butadiene rubber, acrylonitrile polymer, polyurethane, epoxy resins, polyvinyl chloride, polyvinylidene chloride, and copolymers of vinylidene chloride with other monomers, partially hydrolyzed polyvinyl acetate, polyvinyl alcohol, polyvinyl pyrrolidone, polyester resins, and styrene acrylate may be used as a chemical bonding agent. The chemical bonding agent may be applied uniformly by impregnating, coating, or spraying the sheet.

Either after the sheet exits the sheet former 270 or after the optional needling of the sheet, the sheet may be passed through a thermal bonding system 290 to bond the dried chopped glass fibers and bonding fibers 210 and form the chopped strand mat 300. However, it is to be appreciated that if the sheet is needled in the needle felting apparatus 280 and the dried chopped glass fibers and the bonding fibers 210 are mechanically bonded, it may be unnecessary to pass the sheet through the thermal bonding system 290 to form the chopped strand mat 300.

In the thermal bonding system 290, the sheet is heated to a temperature that is above the melting point of the bonding fibers 210 but below the melting point of the dried chopped glass fibers. When bicomponent fibers are used as the bonding fibers 210, the temperature in the thermal bonding system 290 is raised to a temperature that is above the melting temperature of the sheath fibers, but below the melting temperature of the dried chopped glass fibers. Heating the bonding fibers 210 to a temperature above their melting point, or the melting point of the sheath fibers in the instance where the bonding fibers 210 are bicomponent fibers, causes the bonding fibers 210 to become adhesive and bond the bonding fibers 210 both to themselves and to adjacent dried chopped glass fibers. If the bonding fibers 210 completely melt, the melted fibers may encapsulate the dried chopped glass fibers. As long as the temperature within the thermal bonding system 290 is not raised as high as the melting point of the dried chopped strand glass fibers and/or core fibers, these fibers will remain in a fibrous form within the thermal bonding system 290 and chopped strand mat 300.

The thermal bonding system 290 may include any known heating and/or bonding method known in the art, such as oven bonding, oven bonding using forced air, infrared heating, hot calendaring, belt calendaring, ultrasonic bonding, microwave heating, and heated drums. Optionally, two or more of these bonding methods may be used in combination to bond the dried chopped strand glass fibers and bonding fibers 210. The temperature of the thermal bonding system 290 varies depending on the melting point of the particular bonding fibers 210, binder resins, and/or latex polymers used, and whether or not bicomponent fibers are present in the sheet. The chopped strand mat 300 that emerges from the thermal bonding system 290 contains a uniform or substantially uniform distribution of dried chopped glass fibers and bonding fibers 210 which provides improved strength, acoustical and thermal properties, stiffness, impact resistance, and acoustical absorbance to the mat 300. In addition, the chopped strand mat 300 formed has a substantially uniform weight consistency and uniform properties.

The chopped strand mat 300 may be used in numerous applications, such as, for example, a reinforcement material in automotive applications such as in headliners, hood liners, floor liners, trim panels, parcel shelves, sunshades, instrument panel structures, door inners, and the like, in hand lay-ups for marine industries (boat building), vacuum and pressure bagging, cold press molding, matched metal die molding, and centrifugal casting. The chopped strand mat 300 may also be used in a number of non-structural acoustical applications such as in appliances, in office screens and partitions, in ceiling tiles, and in building panels.

It is an advantage of the present invention that the physical properties of the mat may be optimized and/or tailored by altering the weight, length, and/or diameter of the reinforcement and/or bonding fibers used in the chopped strand mat. As a result, a large variety of chopped strand mats and composite products formed from the chopped strand mats can be manufactured.

It is also an advantage that the wet use chopped strand glass fibers formed according to the instant invention provides a chopped strand mat that is static free or substantially static free. The reduction in the occurrence of static electricity on the glass fibers results in an improvement in the ability to control the distribution of the wet use chopped strand glass fibers (or other reinforcement fibers) and bonding fibers in the chopped strand mat, and assists in forming a mat that has a substantially even distribution of glass fibers and bonding fibers.

In addition, the static free wet use chopped strand glass fibers eliminates the need for the presence of anti-static bars or other antistatic equipment in the mat manufacturing line. Further, the static free WUCS eliminates any need for the presence and/or use of an anti-static chemical mixture in the manufacturing line of the chopped strand mat. The reduction or elimination of static electricity on the WUCS fibers also reduces the amount of free fibers or fibers in the air in the workplace and reduces potential irritation to workers forming the mats that may be caused by the “free” glass fibers, thereby creating a worker-friendly environment.

Having generally described this invention, a further understanding can be obtained by reference to certain specific examples illustrated below which are provided for purposes of illustration only and are not intended to be all inclusive or limiting unless otherwise specified.

### EXAMPLE

70 g of a 40% solution of Katax 6660-A (antistatic agent) was added to 15 kg of Owens Corning's size designated 9501 and agitated to homogenize the sizing. The size was applied to glass fibers by application rollers prior to collecting the fibers into strands. The wet use fibers were then chopped and dried for 12 hours at 120° C. The dried glass was subjected to a simulation which replicated the glass friction as seen in a conventional dry-laid sheet molding line. The static generated on the glass fibers was measured using a Rothschild Static-Voltmeter R-4021. Static measurements were taken at 21° C. and 43% relative humidity. The static value of the wet use chopped strand glass fibers treated with the modified sizing containing an antistatic agent was measured at 35 Volts.

For comparison, wet use chopped strand glass fibers were coated with Owens Corning's 9501 size (no added antistatic agent(s)). The wet use glass fibers were chopped, dried, and the static value was measured as described above. The static generated on the glass fibers coated with Owens Corning's 9501 size containing no added antistatic agent(s) was measured at 1000 Volts.

Conventional dry-laid equipment can withstand up to approximately 100 Volts of static electricity on the glass fibers before processing problems such as agglomeration of fibers arise. Thus, a static value of up to approximately 100 Volts is considered to be “static free”. From the data presented above, it can be concluded that the wet use chopped strand glass fibers treated with the modified sizing solution (containing an added antistatic agent) demonstrated a reduced tendency to accumulate static electricity on the wet use chopped strand glass fibers, especially when compared to a size containing no antistatic agent(s). It can also be concluded that the wet use chopped strand glass fibers coated with the modified size composition is “static free”.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A low-static non-woven chopped strand mat comprising:
dried wet use chopped strand glass fibers that have been treated to reduce the occurrence of static electricity on said dried wet use chopped strand glass fibers; and
a thermoplastic bonding material having a melting point less than the melting point of said dried wet use chopped strand glass fibers, said thermoplastic bonding material bonding at least a portion of said dried chopped strand glass fibers and said thermoplastic bonding material; and
wherein said dried wet use chopped strand glass fibers and said thermoplastic bonding material are substantially uniformly distributed throughout said chopped strand mat.

2. The non-woven chopped strand mat of claim 1, wherein said dried wet use chopped strand glass fibers include a surface and at least a portion of said surface of said glass fibers is coated with a size composition containing a film forming agent, a coupling agent, and one or more lubricants in an amount of from about 0.4 to about 2.0% by weight solids.

3. The non-woven chopped strand mat of claim 2, wherein said size composition includes hydrophilic agents in an amount of from about 0.05 to about 0.2% by weight solids.

4. The non-woven chopped strand mat of claim 1, wherein said dried wet use chopped strand glass fibers include a surface and at least a portion of said surface of said glass fibers contains an antistatic agent.

5. The non-woven chopped strand mat of claim 4, wherein said antistatic agent is a component added to a size composition applied to a surface of said dried wet use chopped strand glass fibers, said size composition containing a film forming agent, and a coupling agent, one or more lubricants.

6. The non-woven chopped strand mat of claim 4, wherein said antistatic agent is added to said size composition in an amount of from about 0.05 to about 0.2% by weight.

7. The non-woven chopped strand mat of claim 4, wherein said antistatic agent is selected from quaternary ammonium compounds, teteraethylammonium chloride, lithium chloride, fatty acid esters and ethoxylated amines.

8. A method of forming a low-static non-woven chopped strand mat comprising the steps of:
forming wet use chopped strand glass fibers having an antistatic material applied to at least a portion of a surface thereof;
removing water from said wet use chopped strand glass fibers to form dried chopped strand fibers;
blending said dried chopped fibers and a thermoplastic bonding material to form a mixture of said dried chopped fibers and said thermoplastic bonding material;
forming said mixture of said dried chopped fibers and said thermoplastic bonding material into a sheet; and
bonding at least a portion of said dried chopped fibers and said thermoplastic bonding material to form a chopped strand mat.

9. The method of claim 8, wherein said antistatic material is a member selected from the group consisting of an antistatic agent, a size composition containing a an antistatic agent and a size composition containing hydrophilic agents in an amount of from about 0.05 to about 0.2% by weight, said size composition including a film forming agent, a coupling agent, and a least one lubricant.

10. The method of claim 8, wherein said step of forming said wet use chopped strand glass fibers comprises:
adding an antistatic agent to a size composition including a film forming agent, a lubricant, and a coupling agent; and
applying said size composition containing said antistatic agent to a surface of said wet use chopped strand glass fibers.

11. The method of claim 8, wherein said step of forming said wet use chopped strand glass fibers comprises:
applying an antistatic agent to a surface of said wet use chopped strand glass fibers.

12. The method of claim 8, wherein said step of forming said wet use chopped strand glass fibers comprises:
applying a size composition containing a film forming agent, a lubricant, and a coupling agent to a surface of said wet use chopped strand glass fibers in an amount of from about 0.4 to about 2.0% by weight solids.

13. The method of claim 12, wherein said size composition contains hydrophilic agents in an amount of from about 0.05 to about 0.2% by weight solids.

14. Wet use chopped strand glass fibers for use in a dry-laid process comprising:
wet use chopped strand glass fibers having an antistatic material on at least a portion of a surface thereof.

15. The wet use chopped strand glass fibers of claim 14, wherein said antistatic material is an antistatic agent added to a size composition applied to a surface of said wet use chopped strand glass fibers, said size composition containing a film forming agent, a coupling agent, and one or more lubricants.

16. The wet use chopped strand glass fibers of claim 15, wherein said antistatic agent is added to said size composition in an amount of from about 0.05 to about 0.2% by weight.

17. The wet use chopped strand glass fibers of claim 14, wherein said antistatic material is a size composition including a film forming agent, a coupling agent, and one or more lubricants, said wherein said size composition includes hydrophilic agents in an amount of from about 0.05 to about 0.2% by weight solids.

18. The wet use chopped strand glass fibers of claim 17, wherein said size composition is applied to said wet use chopped strand glass fibers in an amount of from about 0.4 to about 2.0% by weight solids.

19. The wet use chopped strand glass fibers of claim 14, wherein said antistatic material is an antistatic agent selected from quaternary ammonium compounds, teteraethylammonium chloride, lithium chloride, fatty acid esters and ethoxylated amines.
